(19) United States
(12) Patent Application Publication
(10) Pub. No.: US 2013/0076925 A1
(43) Pub. Date: Mar. 28, 2013

(54) ELECTRONIC DEVICE AND IMAGE SENSOR PLANARITY ADJUSTING MODULE

(71) Applicant: Yi-Yuan Tsai, Changhua County (TW)

(72) Inventor: Yi-Yuan Tsai, Changhua County (TW)

(73) Assignee: ALTEK CORPORATION, Hsinchu City (TW)

(21) Appl. No.: 13/295,105

(22) Filed: Nov. 14, 2011

(30) Foreign Application Priority Data
Sep. 22, 2011 (TW) 100134178

(51) Int. Cl. H04N 5/228

(52) U.S. Cl. 348/208.99; 348/E05.024

(57) ABSTRACT

An electronic device having an image sensor planarity adjusting module is provided. The image sensor planarity adjusting module includes a moving base, an image sensing unit, a planarity adjusting plate and a plurality of supporting columns. Herein the top of the supporting columns substantially and uniformly support the planarity adjusting plate so as to adjust the image sensing unit to reach a predetermined planarity.

### CROSS-REFERENCE TO RELATED APPLICATION

This application claims the priority benefit of Taiwan application serial no. 100134178, filed on Sep. 22, 2011. The entirety of the above-mentioned patent application is hereby incorporated by reference herein and made a part of this specification.

### BACKGROUND OF THE INVENTION

1. Technical Field

The present invention relates to an electronic device. More particularly, the present invention relates to an electronic device having an image sensor planarity adjusting module.

2. Description of Related Art

With continuous improvement of image-sensing devices, micro-storage medium, and the reduced production cost, a digital camera market continues to expand, leading to a greater demand for more expensive cameras. However, a user does not hold the camera steady when taking a picture, the image captured by the camera will be fuzzy due to the shake. In particular, when a high magnification telescopic lens is used for capturing an image, minor vibration can cause significant fuzziness in the final picture. Hence, a means of minimizing the shaking of cameras for producing a clearer image is always a major research topic for camera manufacturers.

As for the conventional camera having an anti-shake function, when the image sensor, for example the charge coupled device image sensor (CCD image sensor), coupled to the flexible printed circuit board (FPCB) is fastened to the main board during the fabricating process, there is no any adjusting structure for adjusting the image sensor disposed in the camera. The image quality will be affected if the light passing through the lens module and incident to the image sensor is not perpendicular to the light receiving surface of the image sensor. Thus, without the planarity adjusting structure, the image sensor is easy to be tilted so that the incident light is not perpendicular to the image sensor and it may further affect the image quality. Therefore, the anti-shake structure capable to adjust the image sensor planarity is imperative in the camera manufacturing industry.

### SUMMARY OF THE INVENTION

The present invention provides an electronic device having the advantages of an image sensor planarity adjusting function during the assembling process, simple structure and lost cost.

The present invention provides image sensor planarity adjusting module adapted to adjust the image sensor planarity of an electronic device, having the advantages of simple structure and lost cost.

The present invention provides an electronic device including a main board, a carrying plate, an image sensor planarity adjusting module and a lens module. The carrying plate is disposed on the main board and has a first opening. The image sensor planarity adjusting module is disposed at the first opening and includes a moving base, a fixing plate, an image sensing unit, a planarity adjusting plate and a plurality of supporting columns. The moving base has a second opening. The moving base is accommodated in the first opening. The fixing plate is disposed on the moving base and located at the second opening. The image sensing unit is fixed at the fixing plate. The planarity adjusting plate is disposed at the image sensing unit and located between the moving base and the image sensing unit. The supporting columns are disposed at the moving base. Herein the top of the supporting columns substantially supports the planarity adjusting plate so as to adjust the image sensing unit to reach a predetermined planarity. The lens module disposed at the carrying plate. The image sensor planarity adjusting module is located between the lens module and the main board.

The present invention further provides an image sensor planarity adjusting module disposed in an electronic device. The electronic device includes a main board, a carrying plate and a lens module. The carrying plate is disposed on the main board and has a first opening. The lens module disposed at the carrying plate. The image sensor planarity adjusting module is disposed at the first opening and located between the lens module and the main board. The image sensor planarity adjusting module includes a moving base, a fixing plate, an image sensing unit, a planarity adjusting plate and a plurality of supporting columns. The moving base has a second opening. The moving base is accommodated in the first opening. The fixing plate is disposed on the moving base and located at the second opening. The image sensing unit is fixed at the fixing plate. The planarity adjusting plate is disposed at the image sensing unit and located between the moving base and the image sensing unit. The supporting columns are disposed at the moving base. Herein the top of the supporting columns substantially supports the planarity adjusting plate so as to adjust the image sensing unit to reach a predetermined planarity.

According to an embodiment of the present invention, the image sensing unit includes a flexible printed circuit board and an image sensor. The flexible printed circuit board is disposed at the carrying plate and located between the carrying plate and the moving base.

The image sensor is electrically connected to the flexible printed circuit board and located at the second opening.

According to an embodiment of the present invention, a number of the supporting columns is three, and the top of the three supporting columns forms a reference plane.

According to an embodiment of the present invention, at least one of the supporting columns comprises an elastic element.

According to an embodiment of the present invention, the planarity adjusting plate is a glass plate, a coated glass plate or a transparent coated material.

According to an embodiment of the present invention, the material of the fixing plate is glass, metal or plastic.

According to an embodiment of the present invention, the image sensing unit, the planarity adjusting plate and the supporting columns are fixed by a glue bonding method after the image sensing unit is adjusted to reach the predetermined planarity.

According to an embodiment of the present invention, the moving base has a plurality of guide rods and a driving device, the driving unit drives the moving base so that the moving base is adapted to perform a two dimensional movement along the guide rods.

In light of the above, compared to the conventional electronic device, the electronic device of the present invention can adjust the image sensor to reach a predetermined planarity during the assembling process because of the configuration of the supporting columns and the planarity adjusting plate, so that the electronic device can provide a better image quality. In addition, the structure of the image sensor planarity adjusting module of the present invention is simple, and thus the operators can conveniently adjust the planarity of the image sensor.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of an electronic device according to an embodiment consistent with the invention.

FIG. 2 is a schematic view of an image sensor planarity adjusting module of the electronic device in FIG. 1.

FIG. 3 is an exploded view of the image sensor planarity adjusting module in FIG. 1.

### DESCRIPTION OF EMBODIMENTS

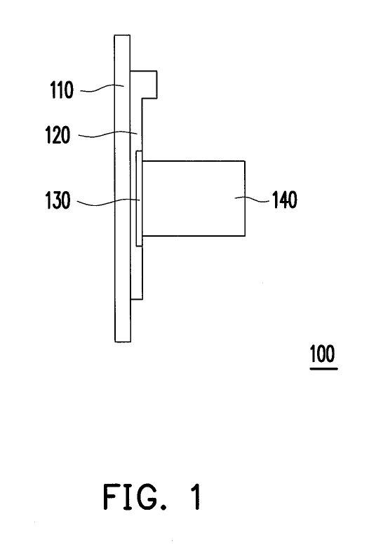

FIG. 1 is a schematic view of an electronic device according to an embodiment consistent with the invention. Referring to FIG. 1, the electronic device 100 of the embodiment includes a main board 110, a carrying plate 120, an image sensor planarity adjusting module 130 and a lens module 140. In the embodiment, the carrying plate 120 of the electronic device 100 is disposed on the main board 110. The lens module 140 is disposed at the carrying plate 120. The image sensor planarity adjusting module 130 is located between the lens module 140 and the main board 110.

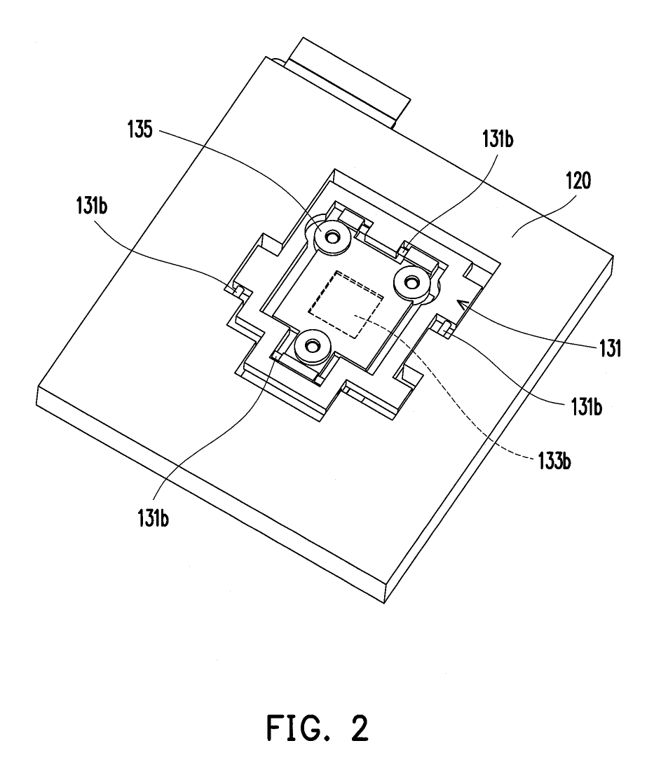

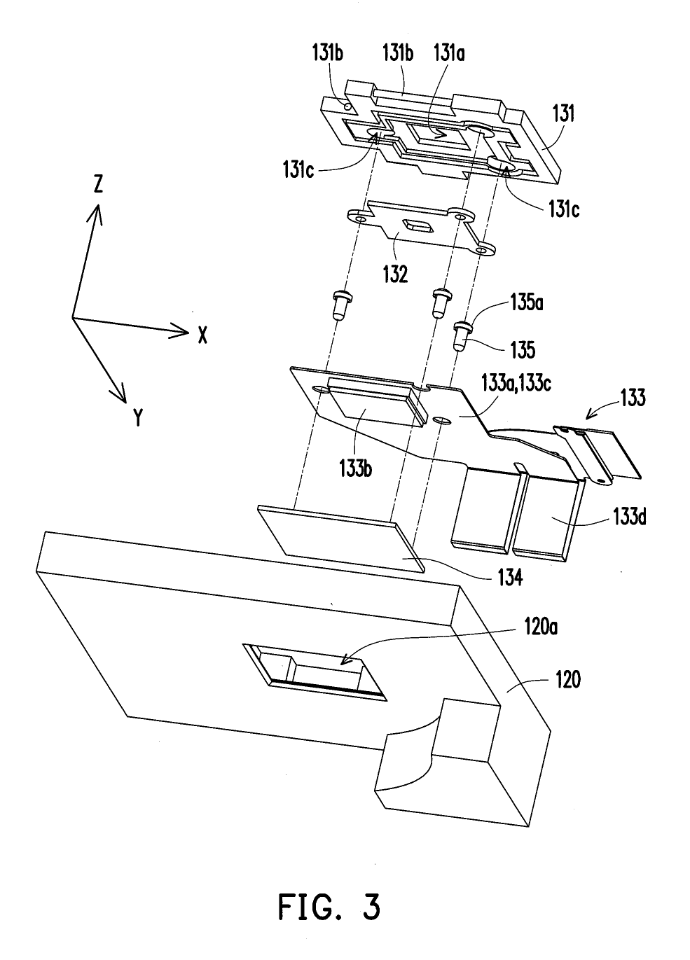

FIG. 2 is a schematic view of an image sensor planarity adjusting module of the electronic device in FIG. 1. FIG. 3 is an exploded view of the image sensor planarity adjusting module in FIG. 1. Referring to FIG. 2 and FIG. 3 together, in the embodiment, the carrying plate 120 of the electronic device 100 is disposed on the main board 110 and has a first opening 120a. The image sensor planarity adjusting module 130 is disposed at the first opening 120a and includes a moving base 131, a fixing plate 132, an image sensing unit 133, a planarity adjusting plate 134 and a plurality of supporting columns 135.

In the embodiment, the moving base 131 has a second opening 131a. The moving base 131 is accommodated in the first opening 120a. The moving base 131 further has a plurality of guide rods 131b and a driving device (not shown). The driving device drives the moving base 131 so that the moving base 131 can perform a two dimensional movement along the guide rods 131b. In other words, the moving base 131 is used to drive the image sensing unit 133 to perform a two dimensional movement so that the electronic device has an anti-shake function. The guide rods 131b can be disposed at the moving base 131 so that the moving base 131 can perform a two dimensional movement along the guide rods 131b, the X, Y directions of FIG. 3. Accordingly, in the embodiment, at the inner side walls of the second opening 131a of the moving base, four guide rods 131b are disposed with the two guide rods 131b in the X direction being perpendicular to the two guide rods 131b in the Y direction.

The fixing plate 132 is disposed on the moving base 131 and located at the second opening 131a. The image sensing unit 133 is fixed at the fixing plate 132. The image sensing unit 133 includes a flexible printed circuit board (FPCB) 133a and an image sensor 133b. The flexible printed circuit board 133a has a board portion 133c and a bending portion 133d. The board portion 133c and the bending portion 133d are connected to each other. The bending portion 133d is flexible so as to provide a dumping effect to the disposed components. The flexible printed circuit board 133a is disposed at the carrying plate 120 and located between the carrying plate 120 and the moving base 131. In the embodiment, the image sensor 133b may be a charge coupled device (CCD) image sensor or a complementary metal oxide semiconductor (CMOS) sensor. The image sensor 133b is electrically connected to the flexible printed circuit board 133a and located at the second opening 131a. The fixing plate 132 and the image sensing unit 133 can be fixed together by using a glue bonding method. In addition, the material of the fixing plate 132 can be glass, metal, plastic or any other suitable material which can encapsulate the image sensor 133, and the present invention is not limited thereto.

In the embodiment, in order to ensure the light passing through the lens module 140 and incident to the image sensor 133b being perpendicular to the image sensor 133b, the planarity adjusting plate 134 is disposed at the image sensing unit 133 and located between the moving base 131 and the image sensing unit 133. The planarity adjusting plate 134 is used to be taken as a datum plane so as to ensure the light passing through the lens module 140 and incident to the image sensor 133b being perpendicular to the image sensor 133b. The planarity adjusting plate 134 can be a glass plate, a coated glass plate, a coated material or any other transparent material, the present invention is not limited thereto.

More specifically, in the embodiment, the planarity of the image sensing unit 133 can be calibrated by the operators during the assembling process of the electronic device 100. For example, the operators can use a laser planarity adjusting device detects the planarity of the image sensor 133b, and the planarity adjusting plate 134 can be taken as a datum plane during the adjusting process of the image sensor 133b to reach a predetermined planarity.

Thus, in order to let the operators can manually adjust the planarity adjusting plate 134 for the image sensor 133b to reach the predetermined planarity, three supporting columns 135 are disposed at the moving base 131 as shown in FIG. 3. Herein the top of the supporting columns 135 substantially supports the planarity adjusting plate 134 so that the operators can manually adjust the height of the supporting columns 135 in order to calibrate the image sensing unit 133 to reach a predetermined planarity. The number of the supporting columns 135 and the location of the disposing of the supporting columns 135 on the moving base 131 are not limited in the present invention. For instance, as shown in FIG. 3, three supporting columns 135 are disposed at the moving base 131 in the embodiment, with one supporting column 135 located at a side of the moving base, and the other two supporting columns 135 respectively located at two corners opposing to the side of the moving base 131, so that the top of the three supporting columns can form a reference plane.

In addition, screw holes 131c can also be disposed at the moving base 131 so that the supporting columns 135 can be disposed at the moving base 131 through the screw holes 131c. For example, the operators can manually rotate the supporting columns 135 during the assembling process to adjust the planarity of the image sensor 133b. During the assembling process of the electronic device 100, once the image sensor 133b is adjusted to reach a predetermined planarity, the image sensing unit 133, the planarity adjusting plate 134 and the supporting columns 135 can be fixed together by using a glue bonding method or a dispensing method, so that the electronic device 100 provides a good image quality.

It should be noted that one or more of the supporting columns 135 can be adjustable supporting columns 135. In other words, if one supporting column 135 is the adjustable supporting column 135, then the other two supporting columns 135 can be fixed supporting columns 135. In the embodiment, the three supporting columns 135 are adjustable supporting columns 135. Thus, as shown in FIG. 3, each supporting column 135 includes an elastic element 135a disposed around the supporting column 135, so that the operators can adjust the planarity of the sensor 133b through the elastic elements 135a. Furthermore, the elastic elements 135a can be springs for example, and the supporting columns 135 can be injection molding plastics, acrylic materials or any other suitable materials, and the present invention is not limited thereto.

In light of the foregoing, compared to the conventional electronic device, the electronic device of the present invention can adjust the image sensor to reach a predetermined planarity during the assembling process because of the configuration of the supporting columns and the planarity adjusting plate, so that the electronic device can provide a better image quality. Additionally, the structure of the image sensor planarity adjusting module of the present invention is simple, and thus the operators can conveniently adjust the planarity of the image sensor to further improve the image quality of the electronic device.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An electronic device, comprising:
a main board;
a carrying plate disposed on the main board and having a first opening;
an image sensor planarity adjusting module disposed at the first opening, comprising:
a moving base having a second opening and accommodated in the first opening;
a fixing plate disposed on the moving base and located at the second opening;
an image sensing unit fixed at the fixing plate;
a planarity adjusting plate disposed at the image sensing unit and located between the moving base and the image sensing unit;
a plurality of supporting columns disposed at the moving plate, wherein the top of the supporting columns substantially supports the planarity adjusting plate so as to adjust the image sensing unit to reach a predetermined planarity; and
a lens module disposed at the carrying plate, wherein the image sensor planarity adjusting module is located between the lens module and the main board.

2. The electronic device as claimed in claim 1, wherein the image sensing unit comprises:
a flexible printed circuit board disposed at the carrying plate and located between the carrying plate and the moving base; and
an image sensor electrically connected to the flexible printed circuit board and located at the second opening.

3. The electronic device as claimed in claim 1, wherein a number of the supporting columns is three, and the top of the three supporting columns forms a reference plane.

4. The electronic device as claimed in claim 1, wherein at least one of the supporting columns comprises an elastic element.

5. The electronic device as claimed in claim 1, wherein the planarity adjusting plate is a glass plate, a coated glass plate or a transparent coated material.

6. The electronic device as claimed in claim 1, wherein the material of the fixing plate is glass, metal or plastic.

7. The electronic device as claimed in claim 1, wherein the image sensing unit, the planarity adjusting plate and the supporting columns are fixed by a glue bonding method after the image sensing unit is adjusted to reach the predetermined planarity.

8. The electronic device as claimed in claim 1, wherein the moving base has a plurality of guide rods and a driving device, the driving unit drives the moving base so that the moving base is adapted to perform a two dimensional movement along the guide rods.

9. An image sensor planarity adjusting module disposed in an electronic device, the electronic device comprising a main board, a carrying plate and a lens module, the carrying plate having a first opening and disposed on the main board, the lens module disposed at the carrying plate, the image sensor planarity adjusting module disposed at the first opening and located between the lens module and the main board, the image sensor planarity adjusting module comprising:
a moving base having a second opening and disposed in the first opening;
a fixing plate disposed on the moving base and located at the second opening;
an image sensing unit fixed at the fixing plate;
a planarity adjusting plate disposed at the image sensing unit and located between the moving base and the image sensing unit; and
a plurality of supporting columns disposed at the moving plate, wherein the top of the supporting columns substantially supports the planarity adjusting plate so as to adjust the image sensing unit to reach a predetermined planarity.

10. The image sensor planarity adjusting module as claimed in claim 9, wherein the image sensing unit comprises:
a flexible printed circuit board disposed at the carrying plate and located between the carrying plate and the moving base; and
an image sensor electrically connected to the flexible printed circuit board and located at the second opening.

11. The image sensor planarity adjusting module as claimed in claim 9, wherein a number of the supporting columns is three, and the top of the three supporting columns forms a reference plane.

12. The image sensor planarity adjusting module as claimed in claim 9, wherein at least one of the supporting columns comprises an elastic element.

13. The image sensor planarity adjusting module as claimed in claim 9, wherein the planarity adjusting plate is a glass plate, a coated glass plate or a transparent coated material.

14. The image sensor planarity adjusting module as claimed in claim 9, wherein the material of the fixing plate is glass, metal or plastic.

15. The image sensor planarity adjusting module as claimed in claim 9, wherein the image sensing unit, the planarity adjusting plate and the supporting columns are fixed by a glue bonding method after the image sensing unit is adjusted to reach the predetermined planarity.

16. The image sensor planarity adjusting module as claimed in claim 9, wherein the moving base has a plurality of guide rods and a driving device, the driving unit drives the moving base so that the moving base is adapted to perform a two dimensional movement along the guide rods.
